(19) United States
(12) Patent Application Publication
(10) Pub. No.: US 2016/0307467 A1
(43) Pub. Date: Oct. 20, 2016

(54) A PORTABLE ELECTRONIC TEST DEVICE AND A METHOD OF USING SAME

(71) Applicant: Johann Pierre Kok, Pretoria (ZA)

(72) Inventor: Johann Pierre Kok, Pretoria (ZA)

(21) Appl. No.: 15/101,261

(22) PCT Filed: Oct. 6, 2015
(86) PCT No.: PCT/ZA2015/050013

§ 371 Date: Jun. 2, 2016

(30) Foreign Application Priority Data
Oct. 9, 2014 (ZA) 2014/07283

(51) Int. Cl. G09B 19/24; G09B 5/12

(52) U.S. Cl. CPC G09B 19/24; G09B 5/125

(57) ABSTRACT

The invention relates to a portable electronic test device which includes a casing which houses therein at least six discrete electronic instruments including an oscilloscope, a spectrum analyser, a logic analyser, a waveform generator, a digital pattern generator and a power supply. The invention extends to a method of assessing an operator's proficiency to use the electronic test device by: crotographically authenticating the operator prior to permitting the operator to use the electronic device using an electronic tag coupled to the electronic device; automatically evaluating, using a computing device, an assignment carried out by the operator using the electronic device; and electronically storing a result of the evaluation on the tag in order to keep track of the operator's proficiency in using the electronic device.

### FIELD OF INVENTION

The invention relates to electronic test equipment and to a method of training or educating users in the use of electronic test equipment and to test or assess their proficiency in doing so.

### BACKGROUND OF INVENTION

Conceptually electronic test and measuring equipment can be divided into two groups of instruments, input instruments and output or measuring instruments. Input instruments provide an electronic circuit with a stimulus or input signal while output or measuring instruments are configured to measure signals produced or present at different points along an electronic or electrical circuit. The measuring instruments allow an operator to “view” signals, which are ordinarily not visible to the human eye, flowing between different electronic components.

Traditionally these instruments were produced as isolated, independent devices designed to perform only one function, for example, viewing an analogue signal (oscilloscope), viewing a digital signal (logic analyser), generating an analogue signal (waveform generator), generating a digital signal (pattern generator), supplying power to an electronic circuit under test (programmable power supply), etc. Accordingly, a conventional electronic workbench would include an arrangement of test equipment or measurement instruments arranged in close proximity to each other for ease of use.

More recently some manufacturers have started to combine two or three different instruments into a single device.

The inventor has identified a need for an educational electronic device having an increased number of instruments integrated therein which are particularly useful in training students in the use of such instruments.

The inventor has also identified a need to log or track development of a student in order to keep track of, or provide evidence of their level of proficiency in using electronic test equipment.

### SUMMARY OF INVENTION

In accordance with the invention, there is provided a method of assessing an operator's proficiency to use an electronic device which includes a casing which houses therein at least five discrete electronic instruments selected from the group including: an oscilloscope;
a spectrum analyser;
a logic analyser;
a waveform generator;
a pattern generator; and
a power supply, the method including:
   authenticating an operator prior to permitting an operator to use the electronic device using an authentication device coupled to or integrally formed with the electronic device;
   automatically evaluating, using a computing device, an assignment carried out by the operator using the electronic device; and
   electronically storing a result of the evaluation in order to keep track of the operator's proficiency in using the electronic device.

The authentication device may be in the form of an electronic tag or dongle which includes an authentication module which has stored thereon a unique identifier associated with the operator. The authenticating step may include:
communicatively coupling the dongle to the electronic device; and
authenticating the operator by communicating the unique identifier stored on the authentication module to the electronic device.

The method may include encrypting the unique identifier associated with the operator.

The step of automatically evaluating an assignment may include:
generating a test signal using the waveform generator or pattern generator of the electronic device;
feeding the test signal to a test circuit operatively connected to the electronic device; and
measuring an output signal using the oscilloscope, spectrum analyser or logic analyser.

The method may include monitoring current drawn by the test circuit using the power supply.

The method may include evaluating, using a computing device, whether or not the output signal falls within a predetermined range in order to establish whether or not the assignment was completed successfully.

The method may further include storing the result of the evaluation on a portable electronic tag or dongle associated with the operator in order to keep track of the operator's progress. Tracking data can also be stored remotely on a server and need not be stored on the dongle. The primary purpose of the dongle may be to identify the operator. As a secondary function, it can store the tracking data.

The method may include authenticating an operator and another third party prior to permitting use of the electronic device using a pair of authentication devices coupled to the electronic device, each authentication device being associated with one of the parties.

The method may also include the step of registering an operator prior to permitting the operator to use the electronic device by associating a unique identifier with the operator. Registering may include taking a biometric measurement of the operator. Alternatively, registering may include storing, in encrypted format, the unique identifier on the portable electronic tag or dongle.

In accordance with a further aspect of the invention, there is provided a portable electronic test device which includes a casing which houses therein at least five discrete electronic instruments selected from the group including:
an oscilloscope;
a spectrum analyser;
a logic analyser;
a waveform generator;
a pattern generator; and
a power supply, wherein the electronic test device is configured to:
   authenticate an operator prior to permitting an operator to use the electronic device using an authentication device coupled to or integrally formed with the electronic device;
   automatically evaluate, using a computing device, an assignment carried out by the operator using the electronic device; and
   electronically store a result of the evaluation in order to keep track of the operator's proficiency in using the electronic device.

The electronic device may further include a digital bus converter and a digital protocol analyser. The electronic device may also include a processor which is communicatively coupled to the respective electronic instruments. Also, the device may include at least one connection port for coupling the electronic device to a computing device such as a laptop, personal computer, tablet, smartphone or other mobile device having a visual or graphical display.

The electronic device may include a plurality of input/output ports arranged about a periphery of the casing which facilitates connection of the respective electronic instruments, housed within the casing, to peripheral test circuits. The casing may define a dock for receiving and supporting a tablet, smartphone or other mobile device having a graphical display. The dock may be in the form of a slot or recess formed in the casing.

The power supply may be configured to measure or monitor current drawn from it by the test circuit and, in the event that current drawn by the test circuit exceeds a predetermined threshold, to interrupt the supply of power to the circuit. The electronic device may further include at least one authentication device in the form of an electronic tag or dongle which is removably connectable/connected to a central processing unit of the electronic test device via a suitable connection port. The authentication device may include a memory module which is configured to store data associated with progress of the operator thereon. The authentication device may also include an authentication module which has stored thereon a unique identifier associated with the operator and which is configured cryptographically to authenticate the operator associated with the authentication device by communicating with the central processing unit.

The invention extends to a computer readable medium having stored thereon a set of instructions, which, when executed by a computing device in communication with the electronic device as described above, allow the device to perform any of the method steps described above.

### BRIEF DESCRIPTION OF DRAWINGS

The invention will now be further described, by way of example, with reference to the accompanying diagrammatic drawings.

In the drawings:

FIG. 1 shows a functional block diagram of a portable electronic test device in accordance with the invention;

FIG. 2 shows a three-dimensional representation of the electronic test device;

FIG. 3 shows a top view of the test device of FIG. 2;

FIG. 4 shows a rear side view of the test device of FIG. 2; and

FIG. 5 shows a functional block diagram of an authentication device removably coupled to the casing of the electronic test device.

### DETAILED DESCRIPTION OF AN EXAMPLE EMBODIMENT

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

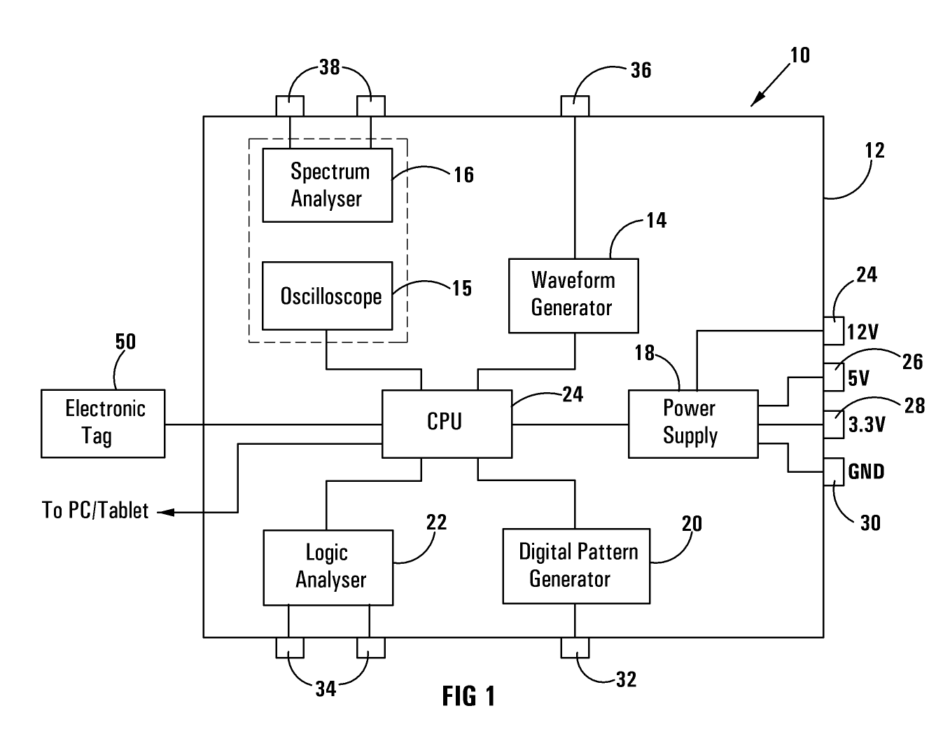

In FIG. 1, reference numeral 10 refers generally to a portable electronic test device in accordance with the invention. The device 10 includes a casing 12 which houses a combination of electronic instruments. These instruments include a waveform generator 14, oscilloscope 15, spectrum analyser 16, programmable power supply 18, digital pattern generator 20 and a logic analyser 22. All the abovementioned instruments are communicatively connected to a central processing unit (CPU) 24. In some embodiments the spectrum analyser 16 and the oscilloscope 15 may be integrated into a single instrument. The device 10 has a number of connectors or ports which provide a physical interface between one or more peripheral circuits and the respective instruments housed in the casing 12. Accordingly, for the power supply the casing 12 has a 12V connector 24, a 5V connector 26, a 3.3V connector 28 and a ground connector 30. Furthermore, the digital pattern generator 20 is connected to a 8/12 bit output channel connector or port 32. The logic analyser 22, in turn, is connected to two input connectors 34. The waveform generator 14 is connector to an output connector 36 and the oscilloscope 15 and spectrum analyser 16 have a pair of input connectors 38.

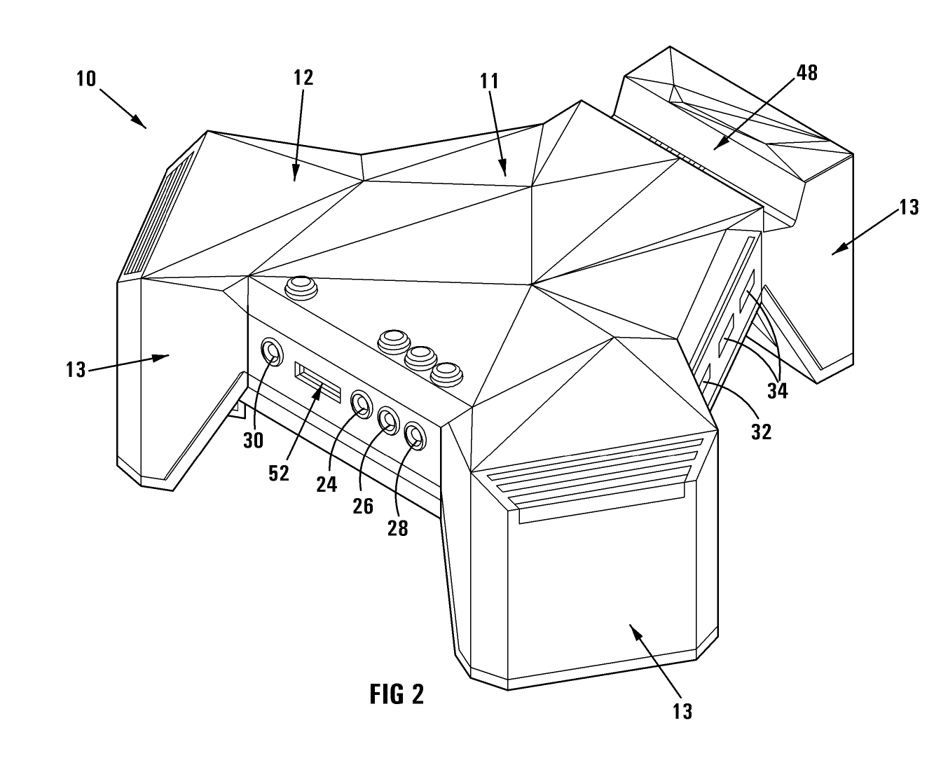

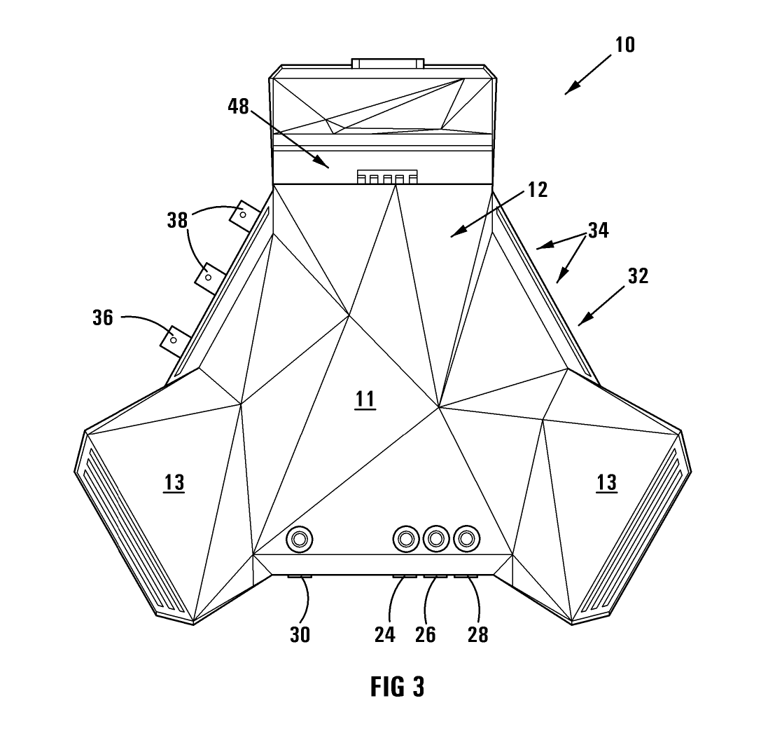

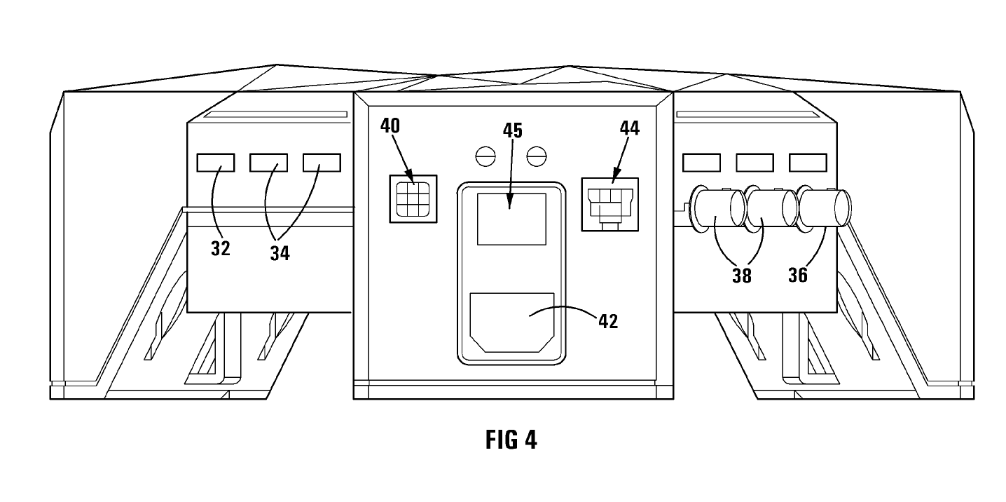

With reference to FIG. 2, the casing 12 of the device 10 has a unique shape and appearance and comprises a roughly triangular middle portion 11, when seen in top view, and three legs 13 which extend outwardly and downwardly from corners of the middle portion 11 at equiangular, spaced apart positions. An upper surface of the casing 12 is multifaceted. The connectors or ports described above are provided on side panels of the middle portion 11 extending between adjacent legs 13 as can be seen in FIGS. 2 to 4. The device 10 further includes a USB connection 40 (see FIG. 4) for coupling the device 10 to a computing device (not shown) in the form of a tablet, smartphone, laptop or personal computer having a graphical display. Naturally other wired/wireless data connections like Bluetooth or Wi-Fi can also be used for coupling the computing device to the electronic device. The scope of the invention is therefore not limited to the example embodiment given herein. Furthermore, a power cord connection 42, Ethernet connection 44 and on/off switch 45 are provided in a side face of one of the legs 13. The casing 12 further defines a dock 48 (see FIG. 2) for receiving and supporting a smartphone or tablet in the form of a recessed slot or groove formed in an upper surface of one leg 13. In use, a side edge of the tablet or smartphone, which is coupled to the device 10 via the USB port 40, is positioned in the slot or dock 48 such that the display of the tablet or phone is orientated angularly upward toward the operator. Instead the computing device may also be in the form of a personal computer having an ordinary screen.

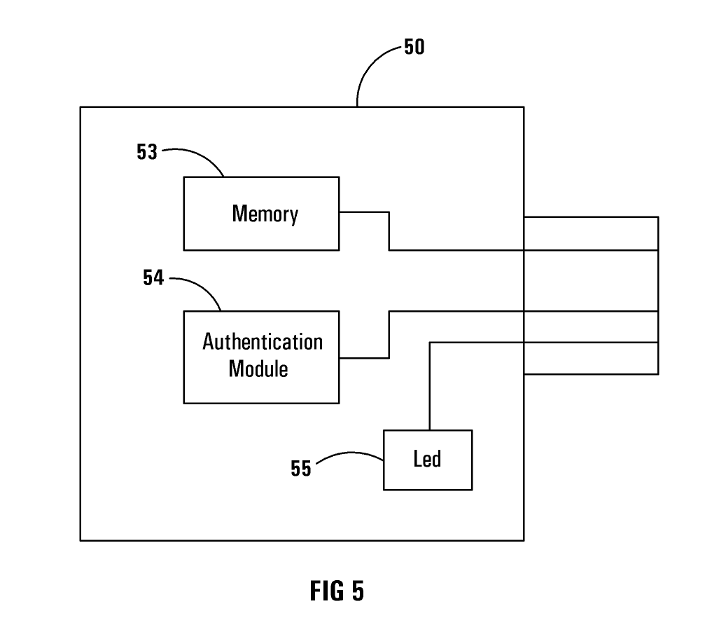

The electronic device 10 further includes at least one authentication device per operator authorised to use the device 10. Accordingly a number of separate authentication devices may be issued, each device being associated with a different user of the device 10. In this example embodiment, the authentication device is in the form of an electronic tag or dongle 50 which is removably coupled to the casing 12 and hence to the central processing unit 24 of the device 10 via a suitable port 52 (see FIG. 2). With reference to FIG. 5, the electronic tag 50 includes a memory module 53, i.e. flash memory, which is configured to store information or data evidencing the progress or development/proficiency of the operator or student to use the device 10. The tag 50 further includes an authentication module 54 which has stored thereon a unique identifier associated with the operator or student. The memory module 53 and authentication module 54 couple to the port 52 via a communication bus. Once inserted into the port 52, and hence connected to the central processing unit 24 of the device 10, by way of an exchange between the CPU and the module 54, the device 10 is configured cryptographically to authenticate the operator associated with the tag 50 prior to permitting the operator to use the device 10. The authentication module 54 supports both symmetrical and asymmetrical encryption. The tag 50 also includes an LED 55 which is lit when the tag is plugged in.

In an alternative embodiment of the invention the authentication device may be in the form of a fingerprint scanner or reader (not shown). Accordingly, the unique identifier associated with each operator will be a biometric parameter such as their fingerprint. To this end, the device 10 may include a fingerprint scanner. The fingerprint scanner could also be part of the electronic tag or dongle 50.

The device further includes at least one digital bus converter and a digital protocol analyser. The bus converter and protocol analyser are completely optional and the device can still perform its core functions of teaching electronics and tracking progress without these components which have not been explicitly shown in the drawings. In an alternative embodiment, the device 10 may also include an integrated graphical display.

There are many advantages of combining the above electronic instruments together into a single test device 10 like cost saving, space saving, wider target market, field of use and easy of use etc.

The electronic test device 10 can be used as an educational tool to train students in the use of the electronic instruments incorporated in the device. The Applicant hopes to change the way students are taught electronics and electricity by having the students perform practical experiments using test circuits which are connected to the power supply and input/output instruments of the device 10 using conventional probes and connecting leads. The Applicant believes students are sometimes equipped with sound theoretical knowledge but with poor practical skills in applying their knowledge.

Students will, for example, start the learning process by using at least three instruments, namely, the waveform generator, oscilloscope and programmable power supply of the electronic test device. As their skill level increases and proficiency levels are reached, more instruments can be introduced into the practical training until the student is eventually proficient in use of all the instruments contained in the electronic test device 10.

Before using the device 10, software written specifically for operation of the device 10 is installed on the computing device, i.e. tablet or smartphone of the student and coupled to the device 10 using the USB connection. The student then plugs his electronic tag 50 into the slot 52 and the device authenticates the student by way of the authentication module 54. Once authenticated the student is authorised to use the device 10. In a preferred embodiment, two electronic tags should be inserted into the device in order to gain access to use the device, the first being associated with the student and the second being associated with a lecturer supervising the student during a practical examination. This scenario of having two tags (student and supervisor) would be preferable for practical examinations but not the rest of the time when learning takes place. Accordingly, both tags would have to be authenticated prior to use.

Once authenticated, the student connects the device 10 to a practical test circuit. By way of example, the student may be required to build a filter to filter out a 1 kHz, 1 Vp-p sine wave on the test circuit such that the amplitude of the signal at the output of the filter is smaller than 0.1 Vp-p. The student then proceeds with the practical assignment and performs the practical experiment by following/executing a set of instructions or prompts displayed on the graphical display of his smartphone, tablet or computer using the installed software. Once the student has completed the practical assignment of building the filter and has connected input and output probes to the test circuit as instructed by the software, the student instructs, via the graphical user interface of the computing device, the device 10 automatically to evaluate his assignment. The device 10 then generates a 1 kHz, 1 Vp-p test signal using the waveform generator 14 of the electronic device which is fed via suitable probes to the filter. The device 10 then automatically measures using the oscilloscope 15 an output signal at the output of the filter and provided the amplitude of the output signal is smaller than 0.1 Vp-p, the software displays a prompt indicating that the student has passed the practical assignment. The student can then proceed to the next assignment. The outcome of the evaluation is then stored via the CPU 24 on the memory module 53 of the electronic tag 50 associated with the student or alternatively it can be sent to Learner Management System (LMS) software on a remote server to keep track and record of the students progress, development and proficiency to use the device 10.

The programmable power supply is configured to monitor current drawn from the device 10 and in the event that the drawn current exceeds a predetermined threshold, the current supply is clamped or shut-off as a precautionary measure. The software is configured to decompress, calculate, output and visually display signals received from the CPU 24 of the device 10 using the graphical display of the computing device. The student can therefore view analogue and digital input/output signals fed/measured from the test circuit on the graphical display. Commands received from the student via the graphical user interface of the computing device are fed back to the device 10 via the USB connection.

By definition engineering is a practical field and it is practical knowledge that makes someone a good engineer and not theoretical knowledge. The reason for this is because in order to pass an exam a student has to memorise knowledge and mathematical formulas and recall it during the exam. In contrast to passing a theoretical exam, if a student passes a practical exam it means he not only possesses the theoretical knowledge but fully processed and integrated it in his thought patterns. This means that the knowledge he gained changed his way of logical thinking and problem solving, so that when he is confronted with a practical problem he seamlessly applies the relevant knowledge in order to solve the problem.

The unique identifier on the authentication module 54 can never be changed or duplicated onto another chip. It can only be read and verified.

Using the Ethernet connection 44 the device 10 can be connected to a network and may allow for remote testing of students.

In one scenario, a school has a classroom with several stations which include the testing equipment of the invention. However, there is no electronics teacher and all the stations are locked to the desks and the students bring their own mobile devices, such as tablets, so the classroom can be left unattended.

The firmware of the stations is “locked” to the electronic tags so that before a station can be used it must be activated by inserting the same tag that students use to write practical exams.

By inserting this tag the child not only activates the station, but also identifies himself as the user thereof. All the measurements he now does as well as the educational videos he watches and the total amount of hours he spends actively using it are collected, digitally signed with his tag, so it can never be changed, and sent to a server or stored on the tag.

The Applicant believes that the electronic test device 10 and method of assessing an operator's proficiency to use an electronic device provides a far more credible way of assessing a student's proficiency than simply looking at exam results. Exam results don't indicate how well a student has integrated the learned knowledge into his problem-solving skills. The advantage of automatic evaluation means that a lecturer or supervisor need not always be present when a practical assignment is carried out. The electronic tag also prevents unauthorised use of the device 10 and keeps track of the operator's progress.

1. A method of assessing an operator's proficiency to use an electronic device which includes a casing which houses therein at least five discrete electronic instruments selected from the group including:
an oscilloscope;
a spectrum analyser;
a logic analyser;
a waveform generator;
a pattern generator; and
a power supply,
the method including:
authenticating an operator prior to permitting an operator to use the electronic device using an authentication device coupled to or integrally formed with the electronic device;
automatically evaluating, using a computing device, an assignment carried out by the operator using the electronic device; and
electronically storing a result of the evaluation in order to keep track of the operator's proficiency in using the electronic device.

2. A method as claimed in claim 1, wherein the authentication device is in the form of an electronic tag or dongle which includes an authentication module which has stored thereon a unique identifier associated with the operator, the authenticating step including:
communicatively coupling the dongle to the electronic device; and
authenticating the operator by communicating the unique identifier stored on the authentication module to the electronic device.

3. A method as claimed in claim 2, which includes encrypting the unique identifier associated with the operator.

4. A method as claimed in claim 1, wherein
the step of automatically evaluating an assignment includes:
generating a test signal using the waveform generator or pattern generator of the electronic device;
feeding the test signal to a test circuit operatively connected to the electronic device; and
measuring an output signal using the oscilloscope, spectrum analyser or logic analyser.

5. A method as claimed in claim 4, which includes monitoring current drawn by the test circuit using the power supply.

6. A method as claimed in claim 4, which includes evaluating, using a computing device, whether or not the output signal falls within a predetermined range in order to establish whether or not the assignment was completed successfully.

7. A method as claimed in claim 6, which includes storing the result of the evaluation on a portable electronic tag or dongle associated with the operator in order to keep track of the operator's progress.

8. A method as claimed in claim 6, which includes storing the result of the evaluation on a remote server in order to keep track of the operator's progress.

9. A method as claimed in claim 1, which includes authenticating an operator and another third party prior to permitting use of the electronic device using a pair of authentication devices coupled to the electronic device, each authentication device being associated with one of the parties.

10. A method as claimed in claim 1, which includes the step of registering an operator prior to permitting the operator to use the electronic device by associating a unique identifier with the operator.

11. A method as claimed in claim 10, wherein registering includes taking a biometric measurement of the operator.

12. A method as claimed in claim 10, wherein registering includes storing, in encrypted format, the unique identifier on a portable electronic tag or dongle associated with the operator.

13. A portable electronic test device which includes a casing which houses therein at least five discrete electronic instruments selected from the group including:
an oscilloscope;
a spectrum analyser;
a logic analyser;
a waveform generator;
a pattern generator; and
a power supply,
wherein the electronic test device is configured to:
authenticate an operator prior to permitting an operator to use the electronic device using an authentication device coupled to or integrally formed with the electronic device;
automatically evaluate, using a computing device, an assignment carried out by the operator using the electronic device; and
electronically store a result of the evaluation in order to keep track of the operator's proficiency in using the electronic device.

14. An electronic test device as claimed in claim 13, which includes a processor which is communicatively coupled to the respective electronic instruments.

15. An electronic test device as claimed in claim 14, which includes at least one connection port for coupling the electronic device to the computing device having a graphical display.

16. An electronic test device as claimed in claim 15, which includes a plurality of input/output ports arranged about a periphery of the casing which facilitates connection of the respective electronic instruments, housed within the casing, to peripheral test circuits.

17. An electronic test device as claimed in claim 16, wherein the casing defines a dock for receiving and supporting a tablet, smartphone or other mobile device having a graphical display.

18. An electronic test device as claimed in claim 17, wherein the power supply is configured to measure current drawn from it by the test circuit and, in the event that current drawn by the test circuit exceeds a predetermined threshold, to interrupt the supply of power to the circuit.

19. An electronic test device as claimed in claim 13, which includes at least one authentication device in the form of an electronic tag or dongle which is removably connectable/connected to a central processing unit of the electronic test device via a suitable connection port, the authentication device including an authentication module which has stored thereon a unique identifier associated with the operator and which is configured cryptographically to authenticate the operator associated with the authentication device by communicating with the central processing unit.

20. An electronic test device as claimed in claim 19, wherein the authentication device includes a memory module which is configured to store data associated with progress of the operator thereon.

21. A non-transitory computer readable medium having stored thereon a set of instructions, which, when executed by a computing device in communication with the electronic device as claimed in claim 13 allow the device to perform the method steps claimed in claim 1.
